(19) United States
(12) Patent Application Publication
(10) Pub. No.: US 2015/0119105 A1
(43) Pub. Date: Apr. 30, 2015

(54) APPARATUS AND METHOD FOR CONTROLLING THE POWERING OF WIRELESS MOBILE DEVICE ACTIVATION

(71) Applicants: Assaf Amgar, Holon (IL); Nissim Zur, Givataim (IL)

(72) Inventors: Assaf Amgar, Holon (IL); Nissim Zur, Givataim (IL)

(21) Appl. No.: 14/067,076

(22) Filed: Oct. 30, 2013

(51) Int. Cl. H04W 52/02; H04M 1/21

(52) U.S. Cl. CPC H04W 52/0254; H04M 1/21; H04W 52/0229; H04W 52/0248
USPC 455/557

(57) ABSTRACT

The present invention provides a control unit configured for being associated with a wireless mobile device and for controlling the powering of the wireless mobile device for minimizing energy usage. The wireless mobile device includes at least a processing unit and a wireless communication module. The control unit comprising: a battery; a clock function unit for measuring time cycle, programmed to send indication at the end of each cycle, a movement sensor programmed to send movement of said wireless mobile device and an electronic switch is configured for powering the wireless mobile device by connecting it to the battery, clock function unit and movement sensor, said switch is activated by the clock function unit when receiving an indication at the end of each cycle or by the movement sensor when receiving an indication of movement.

### BACKGROUND

1. Technical Field

The present invention relates generally to powering wireless mobile device. More particularly, the present invention relates to controlling power of wireless mobile device based on sensor measurements.

2. Discussion of Related Art

Known in the art wireless mobile devices are constantly connect to battery, accordingly, the battery life is relatively short and requires to replace or charge the battery frequently. The present invention provide new electrical configuration for overcoming the deficiency of prior art.

### BRIEF SUMMARY

The present invention provides a control unit configured for being associated with a wireless mobile device and for powering the wireless mobile device for minimizing energy usage. The wireless mobile device includes a processing unit and a wireless communication module. The control unit comprising: a battery, a clock function unit for measuring time cycle, programmed to send indication at the end of each cycle, a movement sensor programmed to send movement indication of said wireless mobile device and characteristics thereof and an electronic switch is configured for powering the wireless mobile device by connecting to the battery, clock function unit and movement sensor. The switch is activated by the clock function unit when receiving an indication at the end of each cycle or by the movement sensor when receiving an indication of movement. The wireless mobile device is activated for limited time period only when the electronic switch is turned on.

According to some embodiments of the present invention the electronic switch is implemented within the wireless mobile device.

According to some embodiments of the present invention the clock function unit and movement sensor are implemented as one or two integrated unit.

According to some embodiments of the present invention the wireless mobile device is connected to the battery using power lines through the electronic switch, such that, when the electronic switch is turned off, the wireless mobile device is disconnected from the battery.

According to some embodiments of the present invention the clock function unit and movement sensor are connected permanently to the battery through power lines.

According to some embodiments of the present invention, upon activation of the wireless mobile device, the processing unit performs a predefined set of actions, optionally including at least one action of transmitting data from the wireless mobile device to an external communication data device through the wireless communication module.

According to some embodiments of the present invention the wireless mobile is turned off after a predefined time period, based on predefined rules.

According to some embodiments of the present invention the wireless mobile is turned off once all defined actions have been completed.

According to some embodiments of the present invention the movement sensor unit comprises a buffer for recording its measurements, wherein once the wireless mobile device is turned on, the recorded data in the buffer is transferred to a processing unit of the wireless mobile device, wherein the processing unit analyzes said recorded measurements for identifying predefined pattern, in case of identified predefined pattern the predefined set of rules is activated, otherwise the wireless mobile device is turned off.

According to some embodiments of the present invention the predefined pattern is determined by analyzing history of movements for detecting patterns by identifying significant or repeating movement pattern indicating of behavior or gesture.

The present invention discloses a method for powering a wireless mobile device, for minimizing battery usage using a clock function unit, a movement sensor and an electronic switch module.

The method comprising the steps of: measuring time cycle by the clock function unit and sending indication at the end of each cycle to the electronic switch, measuring movement of the wireless device by the movement sensor, sending movement indication to the electronic switch, turning on the electronic switch module and powering the wireless mobile device in case of end of time cycle as measured by the clock function unit or by receiving an indication of movement as measured by movement sensor.

### BRIEF DESCRIPTION OF THE DRAWINGS

The present invention will be more readily understood from the detailed description of embodiments thereof made in conjunction with the accompanying drawings of which:

FIG. 1 is a block diagram of the control unit integrated with wireless mobile device, according to some embodiments of the invention;

FIG. 2 is a high level flowchart illustrating the control activation process, according to some embodiments of the invention;

FIG. 3 is a high level flowchart illustrating alternative control activation process, according to some embodiments of the invention;

FIG. 4 is a high level flowchart illustrating the behavior pattern detection, according to some embodiments of the invention;

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The term “Smartphone device” as used herein in this application, is defined as a mobile phone that combines computer capabilities and mobile phone.

The term “wireless mobile device” as used herein in this application, is defined as a mobile device that combines processor capabilities with wireless communication module. The wireless mobile device can function as beacon for sending any data information which can be collected by the sensors.) to a smart phone device, or any mobile communication device which transmit data to a second communication device. The wireless mobile device may include any kind of sensors for measuring the position, motion or movement of the device such as accelerometer, gyro, human bio info health etc. or optionally environmental conditions such as: temperature, humidity etc.

The term “movement sensor” as used herein in this application, is defined as a sensor which tracks the movement or motion of the device on which it is installed, such accelerometer or gyro.

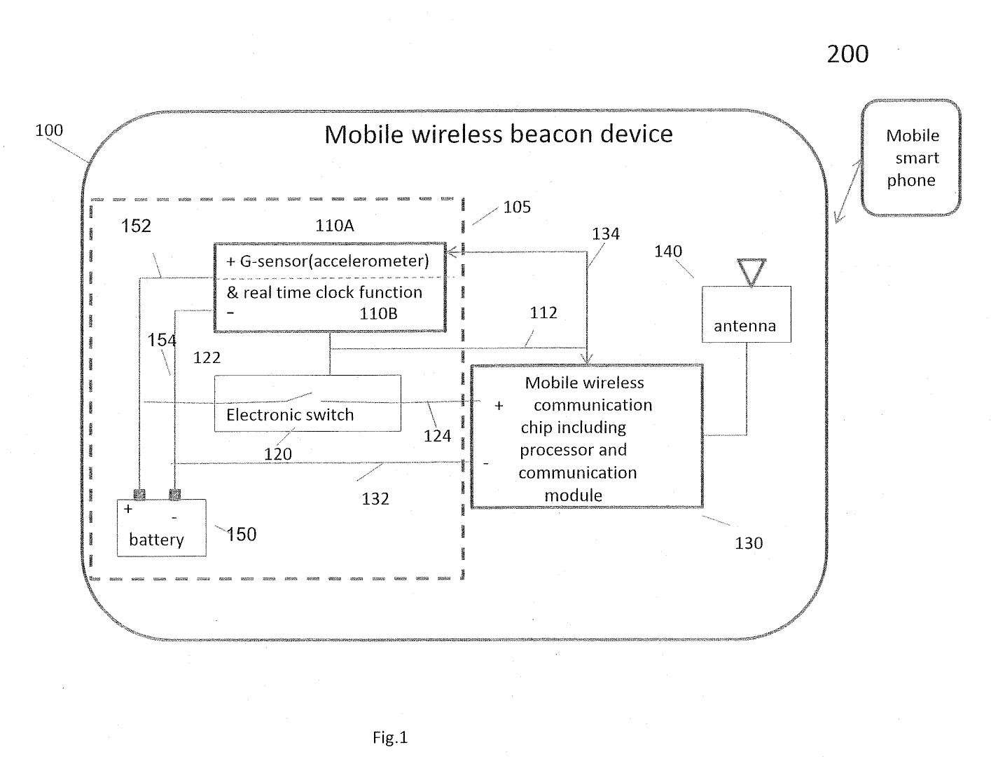

FIG. 1 is a block diagram of the control unit integrated with wireless mobile unit, according to some embodiments of the invention. The control unit 105 includes an electronic switch 120, a battery 150, an antenna 140, a movement sensor unit 110A and real time clock function unit 110B, these two units can be implemented as separate independent units or as one integrated unit.

In the open mode, the electronic switch 120 connects the wireless mobile device to the battery positive pole, though power line 122. On close mode, the wireless mobile device is disconnected from the battery positive pole and is inactive. At both states the wireless mobile device is connected to the battery negative pole through power line 132.

The movement sensor unit 110A and the real time clock function chip 110B are connected to the battery poles through power lines 152 and 154 respectively. The movement sensor and the clock function unit can be programmed by the processor of the mobile wireless unit through communication line 134. The programming may include setting cycle time of the real time clock function chip or sensitivity parameter of the movement sensor. Optionally the communication line 134 may convey data from the movement sensor buffer to the processor.

According to some embodiments the processing unit may instruct/program the sensor unit and clock function chip to maintain the electronic switch open constantly through communication line 112.

According to some embodiments of the present invention the control unit does not include a switch unit, as the switch unit is implemented as part of the mobile wireless unit, in such implementation, a wake-up call is conveyed through communication line 112 for activating the internal electronic switch unit in the wireless communication device.

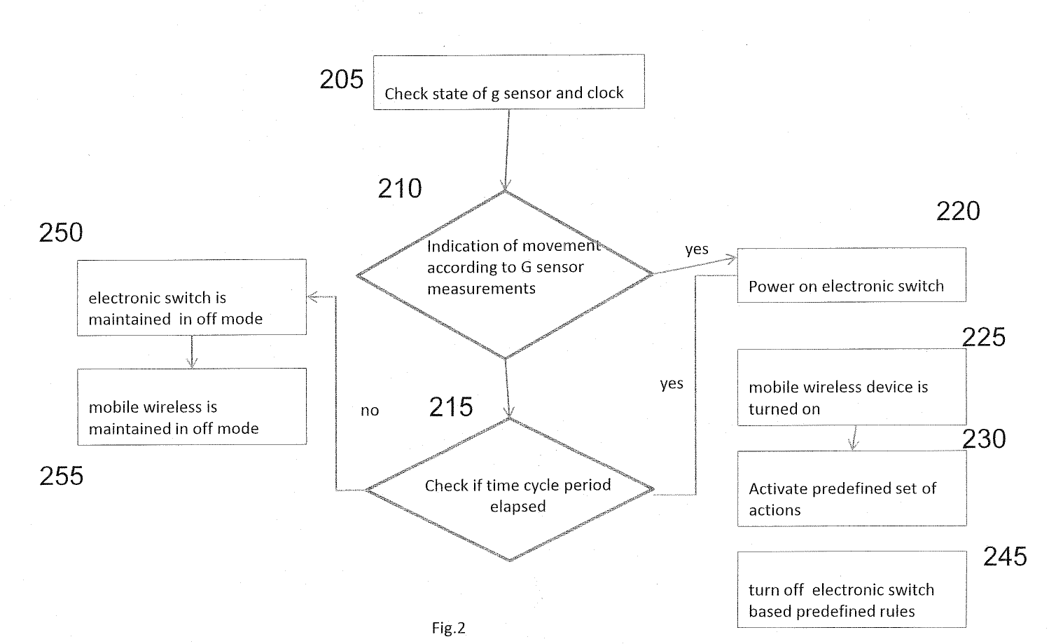

FIG. 2 is a high level flowchart illustrating control activation process, according to some embodiments of the invention. The movement sensor unit and clock function unit are programmed to trigger output signal at the end of a time cycle or when a movement is detected whichever is earlier, hence checking their state (step 205) provides an indication (step 210,215) when to power on the electronic switch (step 220). Once the electronic switch is turned on, the mobile wireless device is activated (step 225). The processor in the mobile wireless device is programmed to perform predefined set of rules, for example, transmitting data by the communication module to any external wireless communication device such as smart phone device. When no indication is received from the movement senor or clock function unit, the electronic switch is maintain in close state (step 250) and the mobile wireless device is maintained in off mode (step 255).

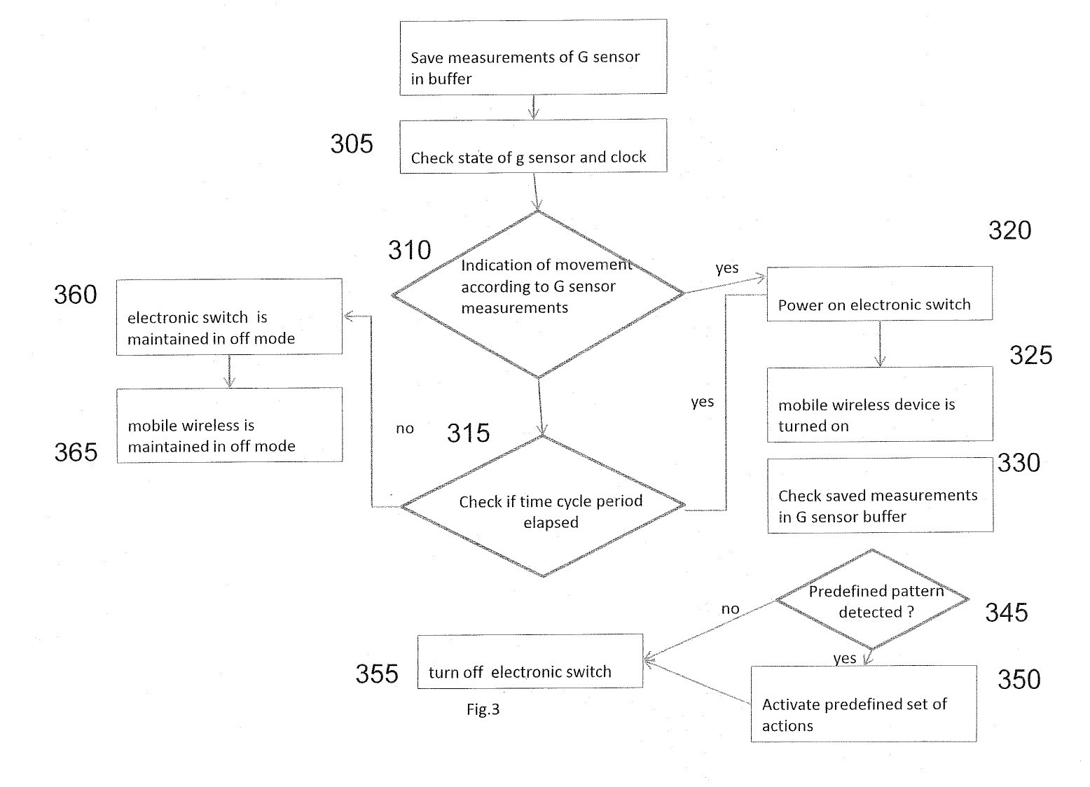

FIG. 3 is a high level flowchart illustrating alternative control activation process, according to some embodiments of the invention. According to this embodiment, the movement sensor unit has buffer for recording short history measurement data (step 302). When receiving an indication of the movement the electronic switch is turned on(step 320), activating the processor of the mobile wireless device (step 325) which retrieves the measurements from the sensor's buffer and analyzes data for identifying predefined gesture pattern (step 330). In case a predefined pattern of gesture is identified (step 345), the wireless device is maintained in active state for performing predefined set of rules (step 350), otherwise the electronic switch is turned off (step 355) disconnecting the wireless mobile device.

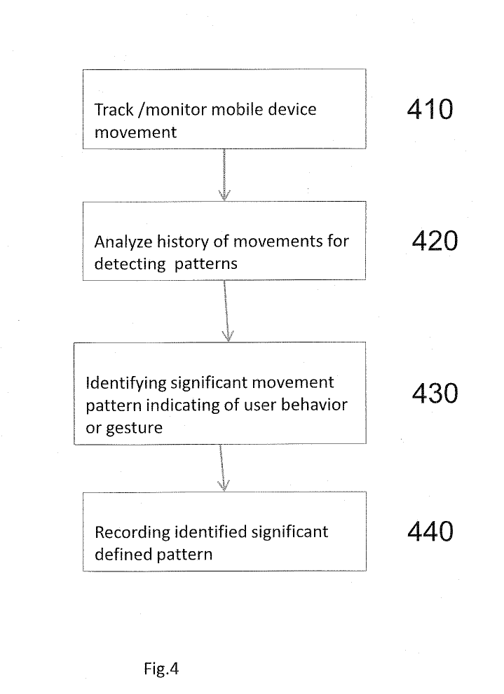

FIG. 4 is a high level flowchart illustrating the behavior pattern detection, according to some embodiments of the invention. For determining the predefined pattern which indicate of a gesture or continuous pattern, the following steps are preformed the: tracking mobile device movement (step 410) based on recorded measurements of movement sensor, analyzing history of movements for detecting patterns (42), identifying significant or repeating movement pattern indicating of specific behavior or gesture and recording identified, significant or repeating defined pattern (430,440). This procedure of identifying the defined pattern can be processed by the processor of the wireless mobile device or by an application implemented on a smart phone device which is associated with the wireless mobile device. The smart phone may check the signal strength of the mobile wireless device for identifying change of distance between the smart phone and the mobile wireless device.

According to some embodiments of the present invention it is suggested to start powering Mobile wireless device only when carried by a user for not wasting the battery power when the Mobile wireless device is left without movement on the table, on the basis of movement sensor measurements and predefined patterns which indicate of movement status. Since the battery power consumption is linear to the time usage only when the mobile wireless device is powered on, the energy saving may be significant, for example powering off the Mobile wireless device when it not used, for a period of 23 hours a day, can extend the battery life in factor of 23.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

What is claimed is:

1. A control unit configured for being associated with a wireless mobile device and for controlling the powering of the wireless mobile device to minimize energy usage, said wireless mobile device includes a processing unit and an wireless communication module, said control unit comprising:
a battery;
a clock function unit for measuring time cycle, programmed to send indication at the end of each cycle;
a movement sensor programmed to send movement measurements of said wireless mobile device; and
an electronic switch configured for powering the wireless mobile device by connecting it to the battery, wherein said switch is activated by the clock function unit when receiving an indication at the end of each cycle or when receiving an indication of movement by the movement sensor;
wherein the wireless mobile device is activated for limited time period only when the electronic switch is turned on.

2. The control unit of claim 1, wherein the clock function unit and movement sensor are implemented as one integrated unit.

3. The control unit of claim 1, wherein the clock function unit and movement sensor are implemented as two separate integrated units.

4. The control unit of claim 1, wherein the wireless mobile device is connected to the battery using power lines through the electronic switch, such that, when the electronic switch is turned off, the wireless mobile device is disconnected from the battery.

5. The control unit of claim 1, wherein the clock function unit and movement sensor are connected permanently to the battery through power lines.

6. The control unit of claim 1, wherein upon the activation of the wireless mobile device, the processing unit performs a predefined set of actions, including at least one action of transmitting data from the wireless mobile device to an external communication data device through the wireless communication module.

7. The control unit of claim 1, wherein the wireless mobile is turned off after a predefined time period, based on predefined rules.

8. The control unit of claim 6, wherein the wireless mobile is turned off once all defined action have been completed.

9. The control unit of claim 1, wherein the movement sensor unit comprises a buffer for recording it's measurements, wherein once the wireless mobile device is turned on, the recorded data in the buffer is transferred to a processing unit of the wireless mobile device, wherein the processing unit analyzes said recorded measurements for identifying predefined pattern, in case of identified predefined pattern the predefined set of rules is activated, otherwise the wireless mobile device is turned off.

10. The control unit of claim 10, wherein the predefined pattern is determined by analyzing history of movements for detecting patterns by identifying significant or repeating movement pattern indicating of behavior or gesture.

11. The control unit of claim 1 wherein the processing unit instructs the sensor unit and clock function chip to maintain the electronic switch open constantly.

12. A method for controlling the activation of a wireless mobile device, for minimizing battery usage using a clock function unit, a movement sensor and an electronic switch module, said method comprising the steps of:
measuring time cycle by the a clock function unit for and sending indication at the end of each cycle to the electronic switch;
measuring movement of the wireless device by the movement sensor,
sending movement indication to the electronic switch; and
turning on the electronic switch module which power on the wireless mobile device in case of end of time cycle as measured by the clock function unit or by receiving an indication of movement as measured by movement sensor;
wherein the wireless mobile device is activated for limited time period only when the electronic switch is turned on;

13. The method of claim 11, wherein upon the activation of the wireless mobile device, the processing unit performs predefined set of actions, including at least one action of transmitting data from the wireless mobile device to an external communication data device through the wireless communication module.

14. The method of claim 11, wherein the wireless mobile is turned off after a predefined time period, based on predefined rules.

15. The method unit of claim 11, wherein the wireless mobile is turned off once all defined action have been completed.

16. The method of claim 11, further recording the sensor measurements by a buffer of the movement sensor, wherein once the wireless mobile device is turned on, the recorded data in the buffer is transferred to a processing unit of the wireless mobile device, wherein the processing unit analyzes said recorded measurements for identifying predefined pattern, in case of identified predefined pattern the predefined set of rules is activated, otherwise the wireless mobile device is turned off.

17. The control unit of claim 10, wherein the predefined pattern is determined by analyzing history of movements for detecting patterns by identifying significant or repeating movement pattern indicating of behavior or gesture.
